(19) United States
(12) Patent Application Publication
(10) Pub. No.: US 2012/0318385 A1
(43) Pub. Date: Dec. 20, 2012

(54) Pressure responsive flow controller

(75) Inventors: Jinhua Lian, Xiamen (CN); Hui Chen, Xiamen (CN)

(73) Assignee: Ateck (Xiamen) Showers Co., Ltd.

(21) Appl. No.: 13/134,779

(22) Filed: Jun. 15, 2011

(51) Int. Cl. F16K 15/00

(52) U.S. Cl. 137/517

(57) ABSTRACT

A flow controller includes a housing having a space formed in one end portion of the housing and communicative with a chamber of the housing, a valve piece slidably engaged in the housing and limited to move relative to the housing and having a compartment formed by a fence and having a passage communicative with the compartment of the valve piece for changeably communicating with the space of the housing and for allowing a communicating area of the passage of the valve piece with the space of the housing to be changed and for allowing a fluid to changeably flow from the space of the housing and through the passage of the valve piece when the valve piece is moved relative to the housing.

### BACKGROUND OF THE INVENTION

1. Field of the Invention

The present invention relates to a flow controller or aerator for a faucet, a shower head, a fluid dispensing device or the like, and more particularly to a flow controller or aerator for a faucet, a shower head, a fluid dispensing device or the like including an improved and simplified structure for suitably supplying a stable flow responsive to different fluid pressures.

2. Description of the Prior Art

Typical flow controllers or aerators for faucets, shower heads, fluid dispensing devices or the like comprise one or more valve members slidably received or engaged in an outer receptacle or housing, and one or more spring-biasing members also received or engaged in an outer receptacle or housing and contacted or engaged with the valve members for controlling the fluid flowing through the receptacle or housing and the valve members.

For example, U.S. Pat. No. 2,896,863 to Shames, et al., U.S. Pat. No. 2,902,224 to Shames, et al., U.S. Pat. No. 3,450,350 to Gullaksen, U.S. Pat. No. 3,684,190 to Bletcher et al., U.S. Pat. No. 4,221,335 to Shames, et al., and U.S. Pat. No. 4,313,564 to Shames, et al. disclose several of the typical flow controllers or aerators each also comprising one or more valve members slidably received or engaged in an outer receptacle or housing, and one or more spring-biasing members engaged with the valve members for controlling the fluid flowing through the receptacle or housing and the valve members.

However, the typical flow controllers or aerators comprise a complicated configuration that may not be easily and quickly manufactured and assembled, in addition, the typical flow controllers or aerators may not be used to supply a stable flow responsive to different fluid pressures.

U.S. Pat. No. 4,562,960 to Marty et al. discloses another typical flow controller or aerator comprising one or more valve members slidably received or engaged in an outer receptacle or housing, and one or more spring-biasing members engaged with the valve members for controlling the fluid flowing through the receptacle or housing and the valve members and in response to the fluid pressure of the fluid flowing through the receptacle or housing for faucets, shower heads or the like.

However, the typical flow controller or aerator also comprises a complicated configuration that may not be easily and quickly manufactured and assembled.

The present invention has arisen to mitigate and/or obviate the afore-described disadvantages of the conventional flow controllers or aerators.

### SUMMARY OF THE INVENTION

The primary objective of the present invention is to provide a flow controller or aerator for a faucet, a shower head, a fluid dispensing device or the like including an improved and simplified structure for suitably supplying a stable flow responsive to different fluid pressures.

In accordance with one aspect of the invention, there is provided a flow controller comprising a housing including a chamber formed therein, and including at least one space formed in a first end portion of the housing and communicative with the chamber of the housing, and including at least one stop, a valve piece slidably engaged in the chamber of the housing at the first end portion of the housing, and including at least one latch for selectively engaging with the stop of the housing and for limiting the valve piece to move relative to the housing and for preventing the valve piece from being disengaged from the housing, the valve piece including a compartment formed therein and including a fence provided on an outer end portion thereof, and the valve piece including at least one passage formed therein and communicative with the compartment of the valve piece for selectively communicating with the space of the housing and for allowing a fluid to flow into the space of the housing and through the passage of the valve piece, and then to flow into the compartment of the valve piece, and a spring biasing member disposed in the chamber of the housing and engaged between the valve piece and the housing for biasing the latch of the valve piece to engage with the stop of the housing, and for communicating the passage of the valve piece with the space of the housing, and a communicating area of the passage of the valve piece with the space of the housing is decreased when the valve piece is forced to move relative and into the housing for decreasing a flowing quantity of the fluid from the space of the housing and into or through the passage of the valve piece, and the communicating area of the passage of the valve piece with the space of the housing is increased or the greatest when the latch of the valve piece is biased to engage with the stop of the housing.

The valve piece includes an opening formed in the fence and communicative with the compartment of the valve piece for allowing the fluid to flow through the opening and into the compartment of the valve piece.

The housing includes at least one channel formed therein, and the latch of the valve piece is slidably engaged with the channel of the housing for selectively engaging with the stop of the housing and for controlling or limiting the valve piece to slide relative to the housing.

The stop of the housing is extended in the channel of the housing for separating the channel of the housing into a front portion and a rear portion and for selectively engaging with the latch of the valve piece.

The housing includes an inclined surface formed on the stop, and the valve piece includes an inclined surface formed on the latch for selectively engaging with the inclined surface of the stop of the housing and for allowing the latch of the valve piece to move over the stop of the housing.

The housing includes an end wall formed on a second end portion of the housing, the chamber of the housing is formed through the end wall of the housing. The channel of the housing is formed through the end wall of the housing and communicative with the chamber of the housing for allowing the fluid to selectively flow out through either the chamber of the housing or the channel of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a flow controller or aerator for a faucet, a shower head, a fluid dispensing device or the like in accordance with the present invention;

FIG. 2 is a plan schematic view of the flow controller or aerator for the faucet, the shower head, the fluid dispensing device or the like, in which a portion of the fluid dispensing device has been cut off for showing the inner structure of the fluid dispensing device;

FIG. 3 is another plan schematic view of the fluid dispensing device having the flow controller or aerator disposed or engaged therein;

FIG. 4 is a perspective view of the flow controller or aerator for the faucet, the shower head, the fluid dispensing device or the like;

FIG. 5 is an exploded view of the flow controller or aerator;

FIG. 6 is another exploded view of the flow controller or aerator as seen from a direction opposite to that shown in FIG. 5;

FIG. 7 is a cross sectional view of the flow controller or aerator, taken along lines 7-7 of FIG. 4;

FIG. 8 is another cross sectional view similar to FIG. 7, illustrating the operation of the flow controller or aerator;

FIG. 9 is a cross sectional view of the flow controller or aerator, taken along lines 9-9 of FIG. 4;

FIG. 10 is another cross sectional view similar to FIG. 9, illustrating the operation of the flow controller or aerator;

FIG. 11 is a further perspective view similar to FIG. 1, illustrating the other arrangement of the flow controller or aerator for the other faucet, the other shower head, the other fluid dispensing device or the like; and

FIGS. 12, 13 are plan schematic views of the flow controller or aerator for the faucet, the shower head, the fluid dispensing device or the like, in which a portion of the other fluid dispensing device has been cut off for showing the inner structure of the other fluid dispensing device.

### DETAILED DESCRIPTION OF THE PREFERRED EMBODIMENT

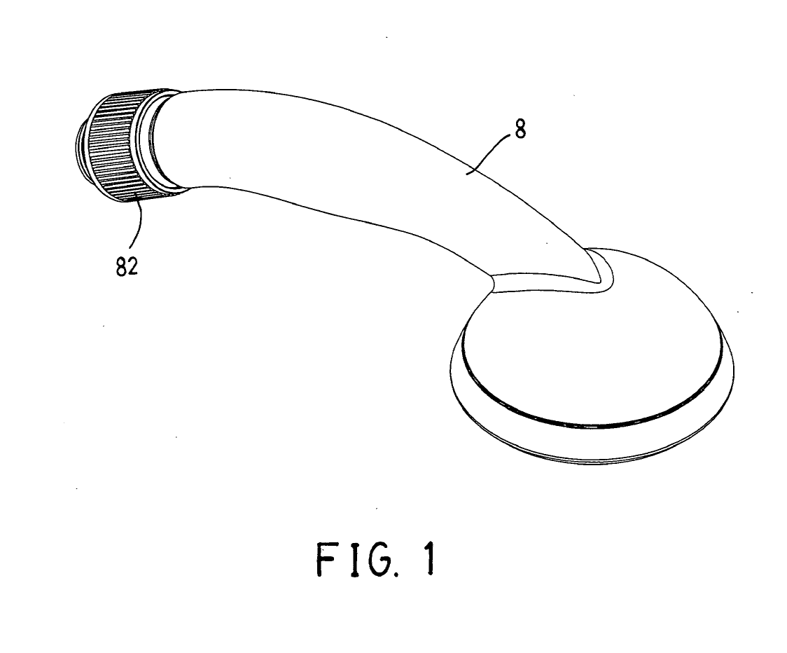

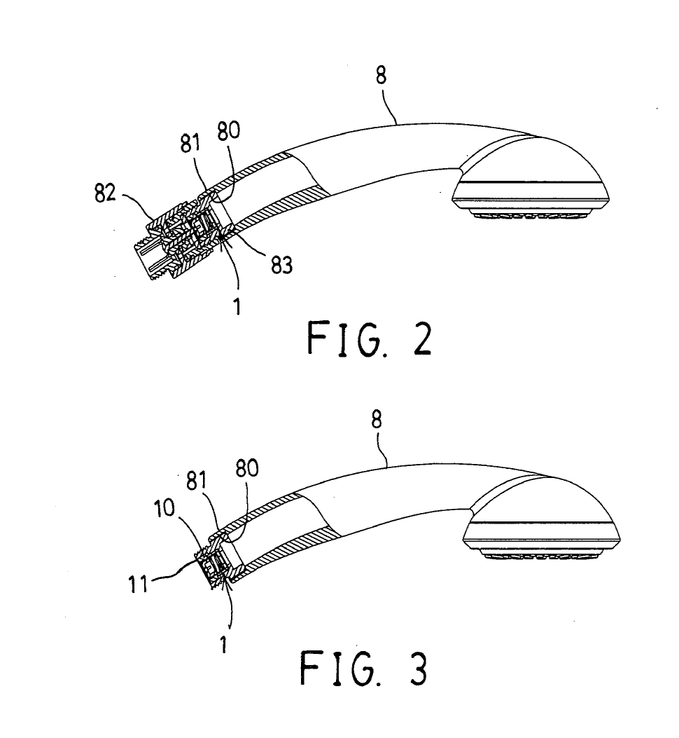

Referring to the drawings, and initially to FIGS. 1-3, a faucet, a shower head, a fluid dispensing device 8 or the like in accordance with the present invention comprises a compartment or space 80 formed in one end portion 81 thereof for receiving or engaging with a flow controller or aerator 1 in accordance with the present invention and for allowing the flow controller or aerator 1 to control the fluid flowing out through the shower head or fluid dispensing device 8 or the like. The shower head or the fluid dispensing device 8 may further include a check valve or control valve 82 attached or mounted or secured to or engaged in the one end portion 81 of the shower head or fluid dispensing device 8 for further controlling the fluid flowing through the shower head or fluid dispensing device 8 or the like.

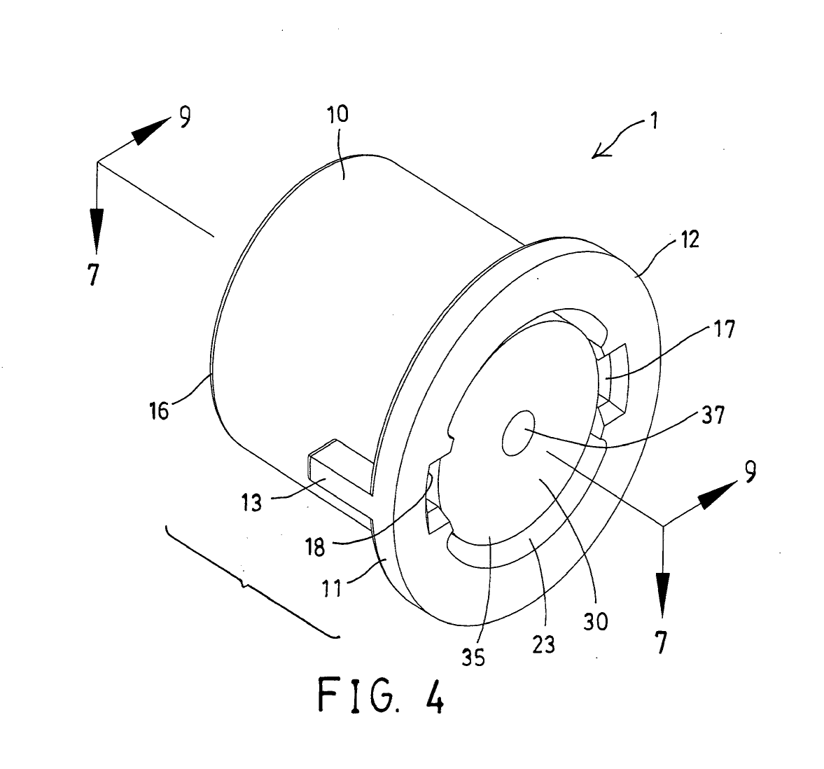

As shown in FIGS. 4-10, the flow controller or aerator 1 includes an outer receptacle or housing 10 having an outer peripheral flange 11 extended radially and outwardly therefrom, such as extended outwardly from the one end or first end portion 12 thereof for engaging with an adapter 83 which may then be received or engaged in the space 80 of the fluid dispensing device 8 and for allowing the housing 10 of the flow controller 1 to be solidly and stably attached or mounted or secured to the fluid dispensing device 8. The fluid dispensing device 8 and the control valve 82 and the adapter 83 are not related to the present invention and will not be described in further details. The housing 10 of the flow controller 1 may further include one or more projections or keys 13 extended outwardly therefrom for engaging with the adapter 83 or the fluid dispensing device 8 and for preventing the housing 10 from being pivoted or rotated relative to the adapter 83 or the fluid dispensing device 8.

The housing 10 includes a bore or chamber 14 formed therein, such as formed in the center portion thereof, and includes an end wall 15 formed or provided on the other end portion 16 thereof, in which the chamber 14 of the housing 10 is also formed through the end wall 15. The housing 10 further includes one or more (such as two) grooves or channels 17, 18 longitudinally and oppositely formed therein and communicative with the chamber 14 of the housing 10, and includes a protrusion or stop 19 extended in each of the channels 17, 18 of the housing 10 for separating each of the channels 17, 18 of the housing 10 into two segments or portions 20, 21, such as a front portion 20 and a rear portion 21, and includes a tapered or inclined surface 22 formed or provided on each of the stops 19. The housing 10 further includes one or more (such as two) depressions or spaces 23 oppositely formed therein, such as formed in the one end portion 12 thereof and communicative with the chamber 14 of the housing 10, but offset or separated from the channels 17, 18 of the housing 10.

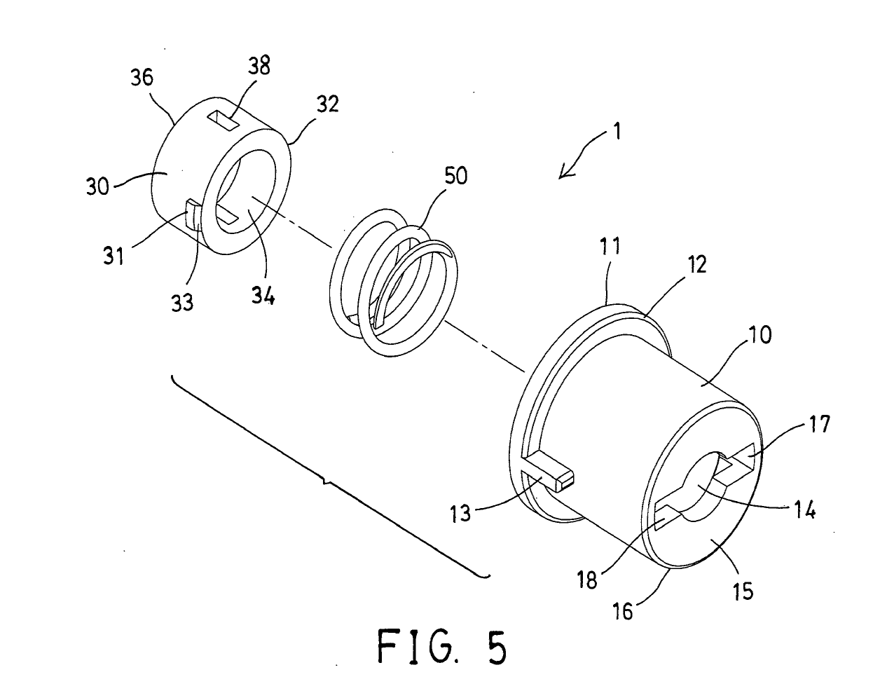

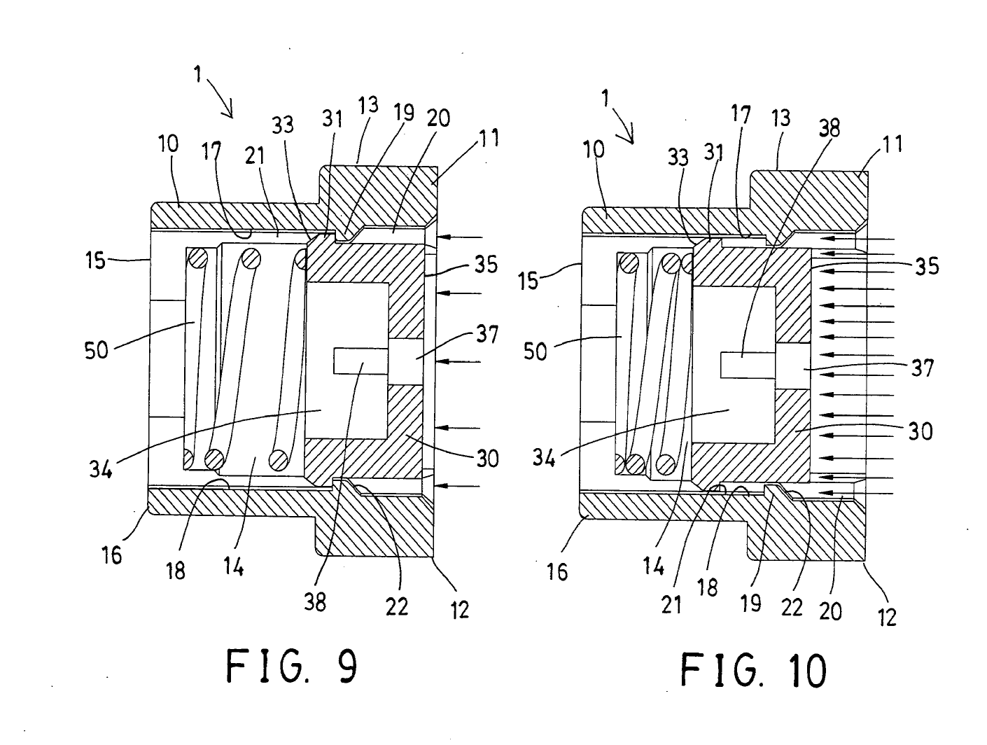

The flow controller 1 further includes a piston or valve piece 30 slidably received or engaged in the chamber 14 and at the one end portion 12 of the housing 10, and includes one or more (such as two) latches 31 extended radially and outwardly therefrom, such as extended outwardly from the one end or inner end portion 32 thereof for slidably engaging with the channels 17, 18 of the housing 10 respectively and for selectively engaging with the stops 19 of the housing 10. For example, the latches 31 of the valve piece 30 each also include a tapered or inclined surface 33 formed thereon (FIGS. 5, 9-10) for engaging with the inclined surface 22 of the stop 19 and for being forced to engage with the inclined surfaces 22 of the stops 19 and forced to move over the stops 19 and forced to move from the front portion 20 to the rear portion 21 of the respective channel 17, 18 of the housing 10, and for slidably attaching or anchoring or securing or retaining the valve piece 30 to the housing 10 (FIGS. 9, 10) and for limiting the valve piece 30 to slide or to move relative to the housing 10, and for preventing the valve piece 30 from being disengaged from the housing 10.

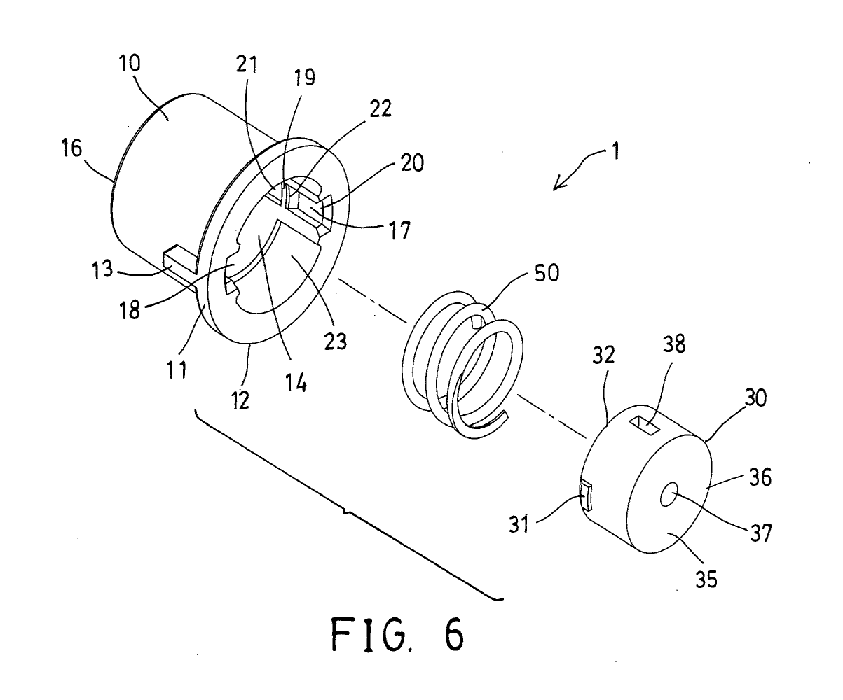

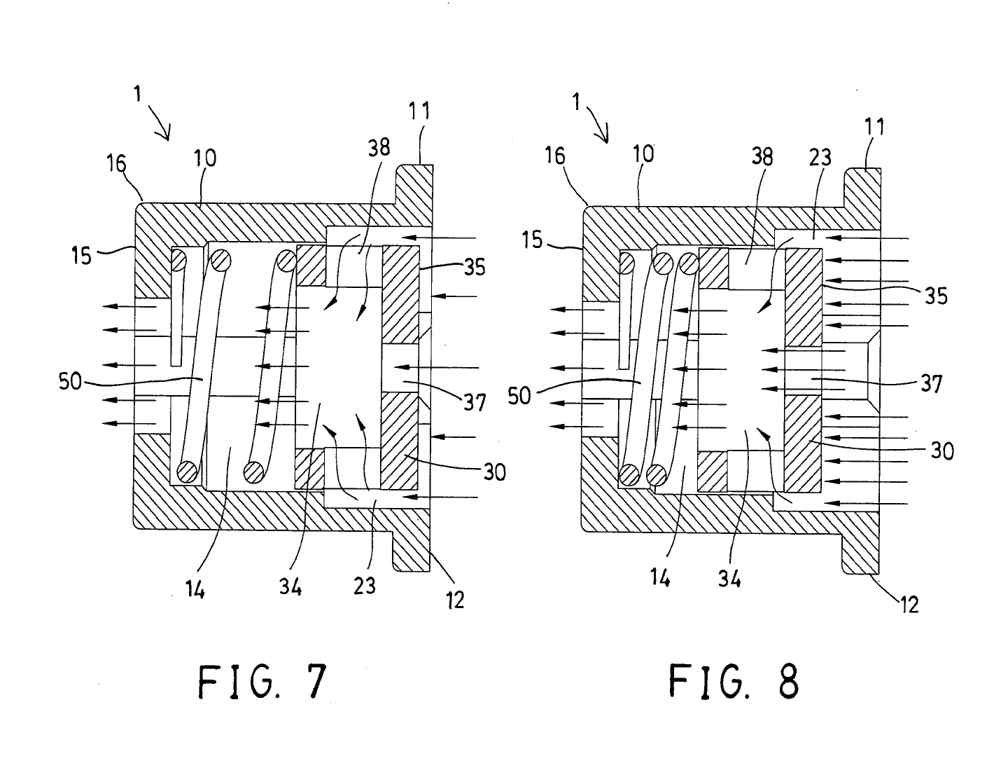

The valve piece 30 includes a bore or compartment 34 formed therein and formed or defined by an end fence 35 which is formed or provided on the other end or outer end portion 36 thereof, in which the end fence 35 includes a bore or opening 37 formed therein (FIG. 6) and communicative with the compartment 34 of the valve piece 30 for allowing the water or fluid to flow through the opening 37 of the fence 35 and to flow into the compartment 34 of the valve piece 30, and then to flow into the chamber 14 of the housing 10. The valve piece 30 further includes one or more (such as two) conduits or passages 38 oppositely formed therein and communicative with the compartment 34 of the valve piece 30, but offset or separated from the latches 31, and aligned with or communicative with the spaces 23 of the housing 10 respectively for allowing the water or fluid to flow into the spaces 23 of the housing 10 and through the passages 38, and then to flow into the compartment 34 of the valve piece 30 (FIGS. 7, 8).

The flow controller 1 further includes a spring biasing member 50 disposed or engaged into the chamber 14 of the housing 10 and engaged between the valve piece 30 and the end wall 15 of the housing 10 for biasing or forcing the valve piece 30 toward the one end portion 12 of the housing 10 (FIGS. 7, 9), and for biasing or forcing the latches 31 of the valve piece 30 to engage with the stops 19 of the housing 10 respectively (FIG. 9). At this moment, as shown in FIGS. 7 and 9, the water or fluid may flow into the spaces 23 of the housing 10 and through the passages 38, and then may flow into the compartment 34 of the valve piece 30 and into the chamber 14 of the housing 10. The water or fluid may also flow onto the fence 35 and through the opening 37 of the fence 35 and may flow into the compartment 34 of the valve piece 30, and may then flow into the chamber 14 of the housing 10.

In operation, as shown in FIGS. 7 and 9, when the water or fluid flows in a relatively less flowing quantity or in a relatively lower fluid pressure that is smaller than the spring biasing force of the spring biasing member 50 and that is not enough to move or force the valve piece 30 to depress the spring biasing member 50, the water or fluid may still flow into the spaces 23 of the housing 10 and through the passages 38, and then may flow into the compartment 34 of the valve piece 30 and into the chamber 14 of the housing 10, simultaneously, the water or fluid may also flow through the opening 37 of the fence 35 and may flow into the compartment 34 of the valve piece 30, and may then flow into the chamber 14 of the housing 10.

As shown in FIGS. 8 and 10, when the water or fluid flows in a relatively greater flowing quantity or in a relatively greater fluid pressure that is greater than the spring biasing force of the spring biasing member 50, the water or fluid may move or force the valve piece 30 to move relative to the housing 10 and to depress the spring biasing member 50 and to disengage the latches 31 of the valve piece 30 from the stops 19 of the housing 10. When the valve piece 30 is forced to move relative to the housing 10, the communicating area of the passage 38 of the valve piece 30 with the space 23 of the housing 10 will be gradually decreased (FIG. 8), such that the flowing quantity of the water or fluid from the spaces 23 of the housing 10 and through the passages 38 of the valve piece 30 may also be gradually or relatively decreased. At this moment, the water or fluid may still flow through the opening 37 of the fence 35 and into the compartment 34 of the valve piece 30. The communicating area of the passage 38 of the valve piece 30 with the space 23 of the housing 10 will be increased or will be the greatest when the latches 31 of the valve piece 30 are forced or biased to engage with the stops 19 of the housing 10 respectively.

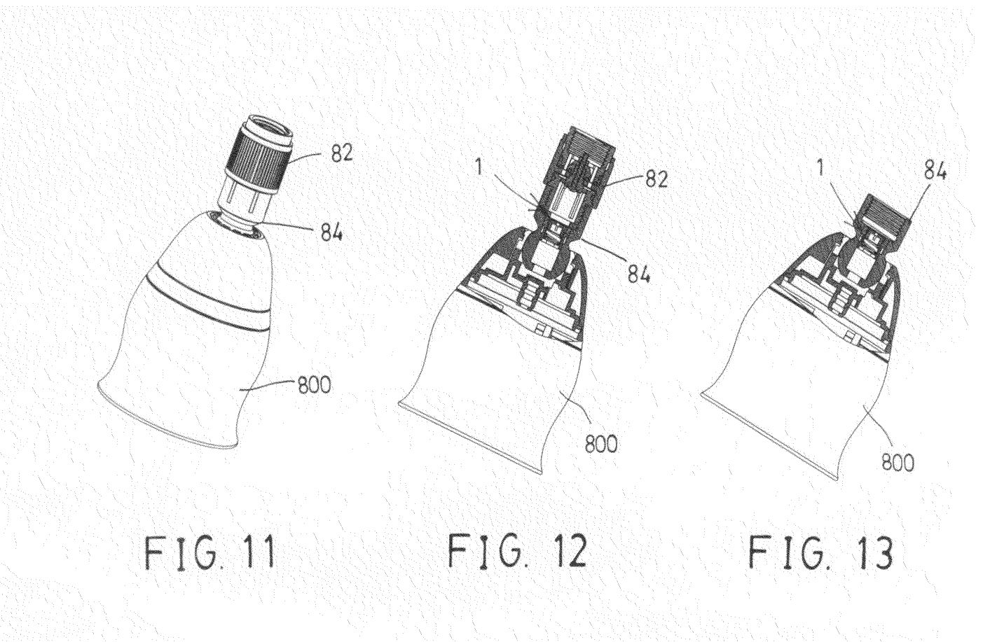

It is to be noted that the flowing quantity of the water or fluid through the compartment 34 of the valve piece 30 and the chamber 14 of the housing 10 may be maintained, or the water or fluid may flow steadily through the compartment 34 of the valve piece 30 and the chamber 14 of the housing 10 when the water or fluid flows in different fluid pressures or flows either in a relatively greater or in a relatively less fluid pressure, and for preventing the water or fluid from flowing out through the housing 10 in a relatively greater flowing quantity when the fluid pressure is relatively greater. Alternatively, as shown in FIGS. 11-13, the flow controller 1 may also be attached or mounted or secured or engaged with the other fluid dispensing devices 800 with the other adapter 84 and/or the control valve 82.

Accordingly, the flow controller or aerator for a faucet, a shower head, a fluid dispensing device or the like in accordance with the present invention includes an improved and simplified structure for suitably supplying a stable flow responsive to different fluid pressures.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A flow controller comprising:
a housing including a chamber formed therein, and including at least one space formed in a first end portion of said housing and communicative with said chamber of said housing, and including at least one stop,
a valve piece slidably engaged in said chamber of said housing at said first end portion of said housing, and including at least one latch for selectively engaging with said at least one stop of said housing and for limiting said valve piece to move relative to said housing and for preventing said valve piece from being disengaged from said housing, said valve piece including a compartment formed therein and including a fence provided on an outer end portion thereof, and said valve piece including at least one passage formed therein and communicative with said compartment of said valve piece for selectively communicating with said at least one space of said housing and for allowing a fluid to flow into said at least one space of said housing and through said at least one passage of said valve piece, and then to flow into said compartment of said valve piece, and
a spring biasing member disposed in said chamber of said housing and engaged between said valve piece and said housing for biasing said at least one latch of said valve piece to engage with said at least one stop of said housing, and for communicating said at least one passage of said valve piece with said at least one space of said housing, and
a communicating area of said at least one passage of said valve piece with said at least one space of said housing being decreased when said valve piece is forced to move relative and into said housing for decreasing a flowing quantity of the fluid from said space of said housing and through said passage of said valve piece, and the communicating area of said at least one passage of said valve piece with said at least one space of said housing being increased when said at least one latch of said valve piece is biased to engage with said at least one stop of said housing.

2. The flow controller as claimed in claim 1, wherein said valve piece includes an opening formed in said fence and communicative with said compartment of said valve piece for allowing the fluid to flow through said opening and into said compartment of said valve piece.

3. The flow controller as claimed in claim 1, wherein said housing includes at least one channel formed therein, and said at least one latch of said valve piece is slidably engaged with said at least one channel of said housing for selectively engaging with said at least one stop of said housing.

4. The flow controller as claimed in claim 3, wherein said at least one stop of said housing is extended in said at least one channel of said housing for separating said at least one channel of said housing into a front portion and a rear portion.

5. The flow controller as claimed in claim 3, wherein said housing includes an inclined surface formed on said at least one stop, and said valve piece includes an inclined surface formed on said at least one latch for selectively engaging with said inclined surface of said at least one stop of said housing.

6. The flow controller as claimed in claim 3, wherein said housing includes an end wall formed on a second end portion of said housing, said chamber of said housing is formed through said end wall of said housing.

7. The flow controller as claimed in claim 6, wherein said at least one channel of said housing is formed through said end wall of said housing and communicative with said chamber of said housing.
